(19) United States
(12) Patent Application Publication
(10) Pub. No.: US 2026/0139710 A1
(43) Pub. Date: May 21, 2026

(54) BEARING DEVICE, METHOD OF MANUFACTURING BEARING DEVICE, HARD DISK DRIVE DEVICE, AND MOTOR

(71) Applicant: MINEBEA MITSUMI Inc., Nagano (JP)

(72) Inventors: Kunihiro TSUCHIYA, Kitasaku-gun (JP); Atsushi KANEKO, Kitasaku-gun (JP); Tadashi UCHIDA, Kitasaku-gun (JP)

(21) Appl. No.: 19/391,030

(22) Filed: Nov. 17, 2025

(30) Foreign Application Priority Data
Nov. 19, 2024 (JP) 2024-201625

(51) Int. Cl. F16C 33/62

(52) U.S. Cl. CPC F16C 33/62; F16C 2223/30

(57) ABSTRACT

A bearing device including a metal constituent member bonded using a delayed ultraviolet curing epoxy-based adhesive, and the constituent member is a member including a dust generation prevention coating formed at a surface of the member or a member subjected to deformation processing. The bearing device holds a sleeve in a rotatable state relative to a shaft by ball bearings. Here, at least one of the shaft and the sleeve is coated with a metallic nickel coating. The metallic nickel coating is a dust generation prevention coating by electroless nickel plating. Alternatively, at least one of the shaft and the sleeve is made of a metal material suitable for deformation processing.

### CROSS-REFERENCE TO RELATED APPLICATIONS

This application claims the benefit of priority to Japanese Patent Application Number 2024-201625 filed on November 19, 2024. The entire contents of the above-identified application are hereby incorporated by reference.

### TECHNICAL FIELD

The disclosure relates to a pivot bearing device for, for example, a hard disk drive device, and particularly to a technique for fixing constituent members using an adhesive.

### BACKGROUND

There is a technique for fixing constituent members of a pivot bearing device with an anaerobic adhesive (see, for example, JP 2022-158038 A).

### SUMMARY

Pivot bearing devices for hard disk drive devices have various requirements. These requirements include, for example, reducing an amount of particles falling off from a surface of the bearing device and reducing manufacturing costs. When materials satisfying these requirements are used, anaerobic adhesives may fail to achieve effective adhesive strength, or a time required for the adhesive to achieve an adhesive effect may increase, resulting in problems such as poor productivity.

Against this background, an object of the disclosure is to provide a technique satisfying requirements for bearing devices assembled using adhesives.

The disclosure relates to a bearing device including a metal constituent member bonded using a delayed ultraviolet curing epoxy-based adhesive, and the constituent member is a member including a dust generation prevention coating formed at a surface of the member or a member subjected to deformation processing.

The disclosure relates to a method of manufacturing a bearing device including forming a dust generation prevention coating at a surface of a member formed of a metal material, and bonding the member and another member using a delayed ultraviolet curing epoxy-based adhesive. The disclosure relates to a method of manufacturing a bearing device including obtaining a member formed of a metal material by deformation processing, and bonding the member and another member using a delayed ultraviolet curing epoxy-based adhesive.

The disclosure relates to a hard disk drive device including a bearing device, and the bearing device includes a metal constituent member bonded using a delayed ultraviolet curing epoxy-based adhesive, and the constituent member is a member including a dust generation prevention coating formed at a surface of the bearing device or a member subjected to deformation processing.

The disclosure relates to a motor including a bearing device, and the bearing device includes a metal constituent member bonded using a delayed ultraviolet curing epoxy-based adhesive, and the constituent member is a member including a dust generation prevention coating formed at a surface of the bearing device or a member subjected to deformation processing.

According to the disclosure, a technique satisfying requirements for bearing devices assembled using adhesives is obtained.

### BRIEF DESCRIPTION OF DRAWINGS

FIG. 1 is a front view illustrating a bearing device according to an embodiment.

FIG. 2A is a cross-sectional view taken along line II-II in FIG. 1, and FIGS. 2B and 2C are partially enlarged views of the cross-sectional view.

FIG. 3 is an enlarged view of a part indicated by arrow III in FIG. 2A.

FIG. 4 illustrates schematic side views describing an assembly process according to the embodiment.

FIG. 5 is a front view illustrating a bearing device according to an embodiment.

FIG. 6 is a cross-sectional view taken along line VI-VI in FIG. 5.

FIG. 7 illustrates schematic side views describing an assembly process according to the embodiment.

FIG. 8 is a perspective view illustrating a hard disk drive device according to an embodiment.

FIG. 9 is a cross-sectional view illustrating a motor according to an embodiment.

FIG. 10 is a cross-sectional view illustrating a bearing device according to an embodiment.

FIG. 11 is a cross-sectional view illustrating a motor including the bearing device according to the embodiment.

FIG. 12 is a cross-sectional view illustrating a modification of the embodiment.

FIG. 13 illustrates schematic side views describing an assembly process according to the embodiment.

FIG. 14 is a cross-sectional view illustrating a bearing device according to an embodiment.

FIG. 15 illustrates schematic side views describing an assembly process according to the embodiment.

### DESCRIPTION OF EMBODIMENTS

### 1 First Embodiment

### 1. Configuration of Bearing Device

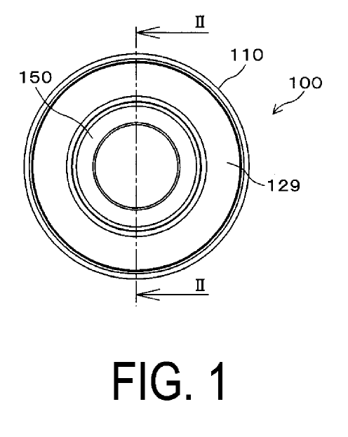

A bearing device according to an embodiment of the disclosure will be described. FIGS. 1 to 4 illustrates a bearing device 100 according to the embodiment of the disclosure. The bearing device 100 includes a sleeve (outer member) 110 made of metal and having a cylindrical shape. The metal forming the sleeve 110 is, for example, stainless steel. When the sleeve 110 is formed by machining, for example, SUS303 is used, and when the sleeve 110 is formed by deformation processing, for example, SUS304 is used.

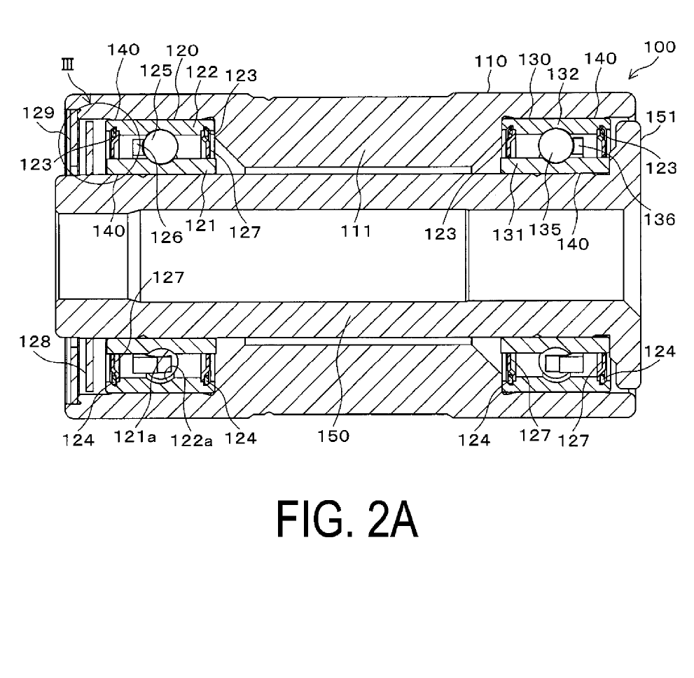

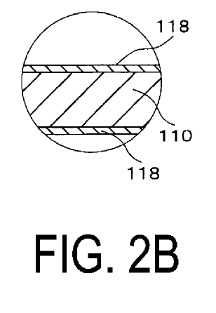

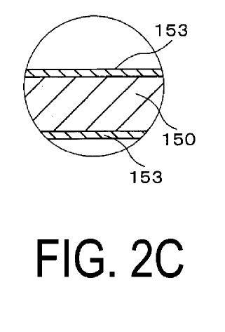

FIG. 2B is an enlarged view of a part of FIG. 2A. As illustrated in FIG. 2B, metallic nickel coatings 118 are formed at surfaces of the sleeve 110 by electroless nickel plating. Note that the metallic nickel coatings 118 are omitted from FIG. 2A.

The metallic nickel coating 118 functions as a dust generation prevention coating configured to suppress generation of particles (particles of a material forming a base material) at the surfaces of the sleeve 110. The sleeve 110 is the base material. A thickness of the metallic nickel coating 118 is selected from a range of 1 μm to 30 μm, and preferably selected from a range of 1 μm to 5 μm. This also applies to a metallic nickel coating 153 and metallic nickel coatings in other embodiments described below. By providing the metallic nickel coatings 118, generation of particles from the surfaces of the sleeve 110 is suppressed.

The bearing device 100 has a structure. In the structure, a shaft 150 and the sleeve 110 are coupled in a relatively rotatable state with ball bearings 120 and 130 interposed between the shaft 150 and the sleeve 110. The ball bearing 120 includes an inner ring 121, an outer ring 122, and balls 125 held between the inner ring 121 and the outer ring 122. The ball bearing 130 includes an inner ring 131, an outer ring 132, and balls 135 held between the inner ring 131 and the outer ring 132. The inner rings 121 and 131, the outer rings 122 and 132, and the balls 125 and 135 are made of known bearing steel.

An inner peripheral protruding part (spacer part) 111 protruding radially inward is formed at an axial central part of the sleeve 110. The first ball bearing 120 and the second ball bearing 130 are fixed to both sides of the inner peripheral protruding part 111 using adhesives 140. End faces of the outer rings 122 and 132 of the first and second ball bearings 120 and 130 are in contact with end faces of the inner peripheral protruding part 111.

Outer peripheral surfaces of the outer rings 122 and 132 are fitted to an inner peripheral surface of the sleeve 110 in a clearance fit relationship as defined by JIS B 0401-1 and -2, and clearances are filled with the adhesives 140. The clearance is preferably 2 to 15 μm. With this structure, the sleeve 110 and the outer ring 122 of the ball bearing 120 are bonded, and the sleeve 110 and the outer ring 132 of the ball bearing 130 are bonded.

The shaft 150 is formed of stainless steel. When the shaft 150 is formed by machining, for example, SUS303 is used, and when the shaft 150 is formed by deformation processing, for example, SUS304 is used.

FIG. 2C is an enlarged view of a part of FIG. 2A. As illustrated in FIG. 2C, metallic nickel coatings 153 are formed at surfaces of the shaft 150 by electroless nickel plating. Note that the metallic nickel coatings 153 are omitted from FIG. 2A. By providing the metallic nickel coatings 153, generation of particles from the surfaces of the shaft 150 is suppressed.

The inner rings 121 and 131 are fixed to the shaft (shaft member) 150 with the adhesives 140. A flange part 151 protruding radially outward is formed at a base end part of the shaft 150. An end face of the inner ring 131 of the second ball bearing 130 is in contact with the flange part 151. Inner peripheral surfaces of the inner rings 121 and 131 are fitted to an outer peripheral surface of the shaft 150 also in a clearance fit relationship as defined by JIS B 0401-1 and -2, and clearances are filled with the adhesives 140. The clearance is also preferably 2 to 15 μm. With this structure, the shaft 150 and the inner ring 121 of the ball bearing 120 are bonded, and the shaft 150 and the inner ring 131 of the ball bearing 130 are bonded.

In FIG. 2A, reference numeral 125 denotes a ball, and a plurality of balls 125 are arranged at regular gaps in a circumferential direction between a raceway surface 121a of the inner ring 121 and a raceway surface 122a of the outer ring 122 by a cage 126. The second ball bearing 130 is also provided with the balls 135 by a similar configuration using a cage 136.

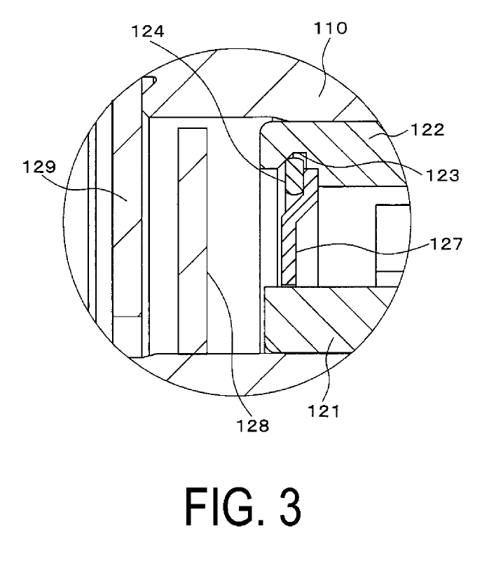

As illustrated in FIG. 3, annular grooves 123 are formed at both axial end parts of an inner peripheral surface of the outer ring 122, C-rings 124 are fitted into the annular grooves 123, and the C-rings 124 press outer peripheral edge parts of seal members 127 against the outer ring 122. Inner peripheral edge parts of the seal members 127 are opposed to an outer peripheral surface of the inner ring 121 with a slight clearance. The seal members 127 are also provided in the second ball bearing 130.

On the other hand, a first hub cap 128 opposed to the first ball bearing 120 is fixed to the outer peripheral surface of the shaft 150. An outer peripheral edge of the first hub cap 128 is opposed to the inner peripheral surface of the sleeve 110 with a slight clearance. A second hub cap 129 opposed to the first hub cap 128 is fixed to an opening of the sleeve 110 by press-fitting or with an adhesive. The second hub cap 129 is ring-shaped, and an inner peripheral edge part of the second hub cap 129 is opposed to the outer peripheral surface of the shaft 150 with a clearance.

Thus, the clearance between the seal member 127 and the inner ring 121 and the first hub cap 128 overlap in an axial direction, and the clearance between the first hub cap 128 and the sleeve 110 and the second hub cap 129 overlap in the axial direction. This effectively suppresses leakage of grease filling a space between the inner ring 121 and the outer ring 122 and intrusion of dust and the like from the outside into the space between the inner ring 121 and the outer ring 122.

On the other hand, by the flange part 151 formed at the base end part of the shaft 150, a clearance between the seal member 127 and the inner ring 131 and the flange part 151 overlap in the axial direction, leakage of grease filling a space between the inner ring 131 and the outer ring 132 and intrusion of dust and the like from the outside into the space between the inner ring 131 and the outer ring 132 are efficiently suppressed.

Here, the metallic nickel coatings 118 and 153 are formed at the surfaces of both the sleeve 110 and the shaft 150 by electroless nickel plating. It is also possible to form the metallic nickel coatings at only one of the sleeve 110 and the shaft 150.

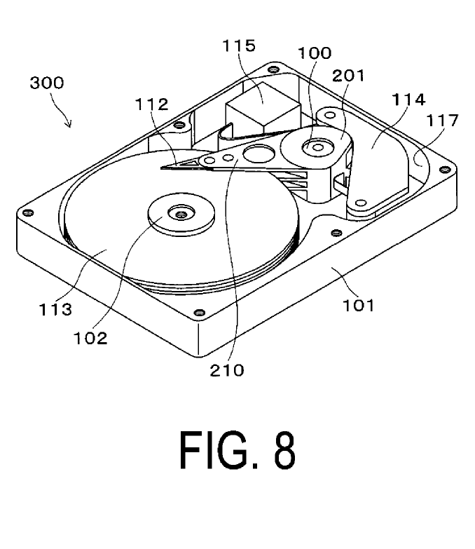

For example, when the bearing device 100 is used in a hard disk drive device 300 illustrated in FIG. 8 (to be described below), an end part of the shaft 150 is exposed to an interior space of the hard disk drive device 300. In order to suppress dust generation from this exposed part, a metallic nickel coating is formed at the surfaces of only the shaft 150.

Here, as the dust generation prevention coating for suppressing generation of particles, an example of the metallic nickel coating formed by electroless nickel plating is described. Examples of the dust generation prevention coating include coatings formed by chromium plating, coatings formed by electrodeposition coating, and epoxy resin coatings. This also applies to the other embodiments.

### 2. Configuration of Adhesive

The adhesive 140 will be described below. Note that the adhesive described below is also used in the other embodiments. The adhesive 140 is a delayed ultraviolet curing epoxy adhesive. The delayed ultraviolet curing epoxy adhesive is used for the following reasons.

For example, SUS303Cu contains copper (Cu) to improve machinability. Cu has a high activity and is easily ionized. When an anaerobic adhesive is used for bonding metals, the anaerobic adhesive is cured by reacting with metal ions present at surfaces of the metals and contributing to a curing reaction. Therefore, SUS303Cu is prone to the curing reaction of the anaerobic adhesive, and is compatible with the anaerobic adhesive.

In contrast, the metallic nickel coating and SUS304 used in the present embodiment do not contain Cu as an additive, so that efficiency of generation of the metal ions contributing to the curing reaction is lower than the efficiency of generation of the metal ions of SUS303Cu, and the curing reaction of the anaerobic adhesive is sluggish. Specifically, this leads to a longer curing time.

A curing mechanism of the delayed ultraviolet curing epoxy adhesives is based on a chemical reaction triggered by irradiation with ultraviolet light and does not depend on a reaction with metal ions. Therefore, a good adhesive effect can be obtained even with materials such as metallic nickel coatings and SUS304. These materials are not compatible with the anaerobic adhesives.

Materials suitable for bonding with the delayed ultraviolet curing epoxy adhesives include metals containing a lower proportion of metal (e.g., Cu) configured to generate metal ions contributing to the curing reaction than SUS303Cu, specifically metals containing 0.05wt.% or less, preferably 0.01wt.% or less, of metal (e.g., Cu) configured to generate metal ions contributing to the curing reaction. Of course, the delayed ultraviolet curing epoxy adhesives can also be used for bonding metals such as SUS303Cu containing metal additives (Cu in this case) contributing to the generation of metal ions contributing to the curing reaction.

A delayed ultraviolet curing epoxy adhesive configured to initiate to cure from 10 seconds to 30 minutes after ultraviolet irradiation is used. The curing initiation time is preferably from 10 seconds to 5 minutes after ultraviolet irradiation. Note that the curing initiation time here refers to a time required for viscosity to increase to 10 times viscosity before the ultraviolet irradiation, after 20 seconds of ultraviolet irradiation at 100 mW/cm² using a UV-LED with a wavelength of 365 nm, while monitoring viscosity increase with a rheometer. Curing is not considered to have initiated until the viscosity increases to 10 times the viscosity before the ultraviolet irradiation. The viscosity of the adhesive at 25°C before curing is preferably 100 to 1000 mPa∙s, and particularly preferably 100 to 400 mPa∙s. When the viscosity is less than 100 mPa∙s, the applied adhesive may flow off, and when the viscosity exceeds 1000 mPa∙s, spring back caused by the adhesive during preloading may prevent the preload from being applied. The viscosity of the adhesive at 25°C before curing or after ultraviolet irradiation is a value measured using a cone-plate rheometer with a diameter of 75 mm and a cone angle of 1.0° at a shear rate of 100/s. The smaller the applied preload is, the more likely the spring back occurs.

In the present embodiment, the preload applied to each bearing of the bearing device may be set to 5 to 30 N, or 7 to 13 N in the axial direction. The adhesive 140 preferably has a viscosity 10000 times greater than the viscosity before the ultraviolet irradiation within 10 minutes, more preferably within 5 minutes, after the curing initiation time described above has elapsed. By using such an adhesive, the time required for a preload application step described below can be appropriately reduced. Note that it is preferable that a natural frequency of the bearing device 100 in the axial direction after the preload application step described below be 80% or more of a natural frequency of the bearing device 100 in the axial direction after a heating step described below. The preload application step may be performed for, for example, from 3 minutes to 30 minutes.

A glass transition temperature of the adhesive after curing is preferably 100°C or higher, and more preferably 120°C or higher. By setting the glass transition temperature in this manner, changes in the natural frequency of the bearing device due to temperature changes can be suppressed. Furthermore, it is preferable that the adhesive composition before curing do not contain particles larger than the minimum value of the clearance for the adhesive.

As the delayed ultraviolet curing epoxy adhesive, an adhesive composed of a bisphenol F liquid epoxy resin, a bisphenol A liquid epoxy resin, a glycidyl compound, and a photopolymerization initiator can be used. Other additives such as modified acrylates may be added as necessary.

In this case, when an entire adhesive component before curing is 100 parts by weight, the delayed ultraviolet curing epoxy adhesive may contain 40 to 60 parts by weight of bisphenol A and bisphenol F in total, 40 to 60 parts by weight of a glycidyl compound, 0.1 to 10 parts by weight of a photopolymerization initiator, and 0.1 to 5 parts by weight of other additives as necessary.

Examples of the glycidyl compound include neopentyl glycol diglycidyl ether, ethylene glycol diglycidyl ether, propylene glycol diglycidyl ether, 1,6-hexanediol diglycidyl ether, glycerol polyglycidyl ether, trimethylolpropane polyglycidyl ether, sorbitol polyglycidyl ether, phenyl glycidyl ether, 2-methylphenyl glycidyl ether, tert-butylphenyl glycidyl ether, 4- chlorophenyl glycidyl ether, 4-methoxyphenyl glycidyl ether, 2-biphenyl glycidyl ether, 1-naphthyl glycidyl ether, methyl glycidyl ether, isopropyl glycidyl ether, butyl glycidyl ether, tert-butyl glycidyl ether, 2-ethyl glycidyl ether, 2-ethylhexyl glycidyl ether, diethylene glycol diglycidyl ether, polyethylene glycol #200 diglycidyl ether, polyethylene glycol #400 diglycidyl ether, tripropylene glycol diglycidyl ether, polypropylene glycol #400 diglycidyl ether, and glycerin diglycidyl ether, and these can be used alone or in combination of two or more. The viscosity of the glycidyl compound at 25°C is preferably 30 mPa∙s or less, more preferably 20 mPa∙s or less, and still more preferably 10 mPa∙s or less.

Examples of the photopolymerization initiator include salts containing cation species such as iodonium-based cation species or sulfonium-based cation species, and anion species such as phosphorus-based anion species or boron-based anion species, and these can be used alone or in combination of two or more. Specific examples include, but are not limited to, the following.

Examples of the iodonium-based cation species include diphenyliodonium, di-p-tolyliodonium, bis(4-dodecylphenyl)iodonium, bis(4-methoxyphenyl)iodonium, (4-octyloxyphenyl)phenyliodonium, bis(4-decyloxyphenyl)iodonium, 4-(2-hydroxytetradecyloxy)phenylphenyliodonium, 4-isopropylphenyl(p-tolyl)iodonium, and isobutylphenyl(p-tolyl)iodonium.

Examples of the sulfonium-based cation species include triarylsulfonium such as triphenylsulfonium, tri-p-tolylsulfonium, tri-o-tolylsulfonium, 4-(phenylthio)phenyldiphenylsulfonium, bis[4-(diphenylsulfonio)phenyl]sulfide, 5-(4-methoxyphenyl)thianthrenium, 5-(4-ethoxyphenyl)thianthrenium, and 5-(4-(2-hydroxyethoxy)phenyl)thianthrenium; diarylsulfonium such as diphenylphenacylsulfonium, diphenyl(4-nitrophenacyl)sulfonium, diphenylbenzylsulfonium, and diphenylmethylsulfonium; and monoarylsulfonium such as phenylmethylbenzylsulfonium, (4-hydroxyphenyl)methylbenzylsulfonium, (4-methoxyphenyl)methylbenzylsulfonium, (4-acetocarbonyloxyphenyl)methylbenzylsulfonium, (2-naphthyl)methylbenzylsulfonium, (2-naphthyl)methyl[(1-ethoxycarbonyl)ethyl]sulfonium, phenylmethylphenacylsulfonium, (4-hydroxyphenyl)methylphenacylsulfonium, (4-methoxyphenyl)methylphenacylsulfonium, (4-acetocarbonyloxyphenyl)methylphenacylsulfonium, (2-naphthyl)methylphenacylsulfonium, (2-naphthyl)octadecylphenacylsulfonium, and (9-anthracenyl)methylphenacylsulfonium.

Examples of the phosphorus-based anion species include hexafluorophosphoric acid and fluorinated alkyl fluorophosphoric acid. Specific examples of preferred fluorinated alkyl fluorophosphate anions include [(CF₃CF₂)₂PF₄]⁻, [(CF₃CF₂)₃PF₃]⁻, [((CF₃)₂CF)₂PF₄]⁻, [((CF₃)₂CF)₃PF₃]⁻, [(CF₃CF₂CF₂)₂PF₄]⁻, [(CF₃CF₂CF₂)₃PF₃]⁻, [((CF₃)₂CFCF₂)₂PF₄]⁻, [((CF₃)₂CFCF₂)3PF3]⁻, [(CF₃CF₂CF₂CF₂)₂PF₄]⁻, and [(CF₃CF₂CF₂CF₂)₃PF₃]⁻. Among these, [(CF₃CF₂)₃PF₃]⁻, [(CF₃CF₂CF₂)₃PF₃]⁻, [((CF₃)₂CF)₃PF₃]⁻, [((CF₃)₂CF)₂PF₄]⁻, [((CF₃)₂CFCF₂)₃PF₃]⁻, and [((CF₃)₂CFCF₂)₂PF₄]⁻ are particularly preferred. Examples of the boron-based anion species include tetrafluoroboric acid and tetrakis(pentafluorophenyl)boric acid.

Specific examples of the photopolymerization initiator include CPI-100P, CPI-101A, CPI-110B, CPI-200K, CPI-210S, IK-1, IK2, CPI-410S, and HS-1A manufactured by San-Apro Ltd., WPI-113, WPI-116, WPI-169, WPI-170, WPAG-336, WPAG-367, WPAG-370, WPAG-469, and WPAG-638 manufactured by Wako Pure Chemical Industries, Ltd., ADEKA OPTOMER SP-103, SP-150, SP-151, SP-170, SP-171, and SP-172 manufactured by ADEKA CORPORATION, PC-2506, PC-2508, and PC-2520 manufactured by Polyset Co., Inc., SAN-AID SI-60, SI-80, SI-100, SI-60L, SI-80L, SI-100L, SI-L145, SI-L150, SI-L160, SI-L110, and SI-L147 manufactured by SANSHIN CHEMICAL INDUSTRY CO., LTD., and BLUESIL PI2074 manufactured by Bluestar Silicones HK Trading Co., Ltd., but the photopolymerization initiator is not limited to these.

As another delayed ultraviolet curing epoxy adhesive, an adhesive composed of an alicyclic epoxy resin, an oxetane compound, a photopolymerization initiator, and a photosensitizer can be used. Other additives such as modified acrylates may be added as necessary.

In this case, when an entire adhesive component before curing is 100 parts by weight, the delayed ultraviolet curing epoxy adhesive may contain 75 to 97 parts by weight of an alicyclic epoxy resin, 1 to 15 parts by weight of an oxetane compound, 0.1 to 10 parts by weight of a photopolymerization initiator, 0.1 to 10 parts by weight of a photosensitizer, and 0.1 to 5 parts by weight of other additives as necessary.

The alicyclic epoxy resins include 3,4-epoxycyclohexylmethyl-3,4-epoxycyclohexanecarboxylate-based compounds, and examples of the alicyclic epoxy resins include 3,4-epoxycyclohexylmethyl-3,4-epoxycyclohexanecarboxylate; 3,4-epoxy-1-methylcyclohexyl-methyl-3,4-epoxy-1-methylcyclohexanecarboxylate; 6-methyl-3,4-epoxycyclohexylmethylmethyl-6-methyl-3,4-epoxycyclohexanecarboxylate; 3,4-epoxy-2-methylcyclohexylmethyl-3,4-epoxy-2-methylcyclohexanecarboxylate; 3,4-epoxy-3-methylcyclohexyl-methyl-3,4-epoxy-3-methylcyclohexanecarboxylate; and 3,4-epoxy-5-methylcyclohexyl-methyl-3,4-epoxy-5-methylcyclohexanecarboxylate. The alicyclic epoxy resins preferably have a viscosity of 400 mPa∙s or less at 25°C.

Examples of the oxetane compound include 3-ethyl-3-hydroxymethyloxetane, 3-(meth)allyloxymethyl-3-ethyloxetane, (3-ethyl-3-oxetanylmethoxy)methylbenzene, 4-fluoro-[1- (3-ethyl-3-oxetanylmethoxy)methyl]benzene, [1-(3-ethyl-3-oxetanylmethoxy)ethyl]phenyl ether, isobutoxymethyl (3-ethyl-3-oxetanylmethyl) ether, 2-ethylhexyl (3-ethyl-3-oxetanylmethyl) ether, ethyl diethylene glycol (3-ethyl-3-oxetanylmethyl) ether, tetrahydrofurfuryl (3-ethyl-3-oxetanylmethyl) ether, tetrabromophenyl (3-ethyl-3-oxetanylmethyl) ether, 2-tetrabromophenoxyethyl (3-ethyl-3-oxetanylmethyl) ether, pentachlorophenyl (3-ethyl-3-oxetanylmethyl) ether, pentabromophenyl (3-ethyl-3-oxetanylmethyl) ether, ethylene glycol bis(3-ethyl-3-oxetanylmethyl) ether, triethylene glycol bis(3-ethyl-3-oxetanylmethyl) ether, tetraethylene glycol bis(3-ethyl-3-oxetanylmethyl) ether, trimethylolpropane tris(3-ethyl-3-oxetanylmethyl) ether, pentaerythritol tris(3-ethyl-3-oxetanylmethyl) ether, pentaerythritol tetrakis(3-ethyl-3-oxetanylmethyl) ether, dipentaerythritol tetrakis(3-ethyl-3-oxetanylmethyl) ether, and ditrimethylolpropane tetrakis(3-ethyl-3-oxetanylmethyl) ether.

As the photopolymerization initiator, for example, in addition to triarylsulfonium salts, photopolymerization initiators equivalent to the above-mentioned photopolymerization initiators can be used. Among these, triarylsulfonium salts are preferred. Specific examples of the photopolymerization initiators include photopolymerization initiators equivalent to the above-mentioned photopolymerization initiators, such as CPI-100P manufactured by San-Apro Ltd.

Next, the photosensitizer may be any compound configured to increase photoactivity of the composition when combined with the photopolymerization initiator, and the type of sensitization mechanism, such as energy transfer, electron transfer, or proton transfer does not matter. From the viewpoint of compatibility with the above photopolymerization initiators and excellent photocurability, radical polymerization initiators, aromatic hydrocarbons, nitro compounds, and the following dyes are preferred. For example, it is preferably selected from aromatic hydrocarbons (e.g., 9,10-dibutoxyanthracene) selected from the group consisting of benzyl ketal-based photoradical polymerization initiators, α-hydroxyacetophenone-based photoradical polymerization initiators, benzoin-based photoradical polymerization initiators, aminoacetophenone-based photoinitiators, oxime ketone-based photoradical polymerization initiators, acylphosphine oxide-based photoradical polymerization initiators, naphthalene derivatives, and anthracene derivatives; nitro compounds selected from the group consisting of nitrobenzoic acid and nitroaniline; or dyes selected from the group consisting of riboflavin, rose bengal, eosin, erythrosine, methylene blue, and new methylene blue rose.

Further, examples of the photosensitizers include anthracenes such as 9-fluorenone, 2-hydroxy-9-fluorenone, 2-amino-9-fluorenone, fluorene, 2-bromofluorene, 9-bromofluorene, 9,9-dimethylfluorene, 2-fluorofluorene, 2-iodofluorene, 2-fluorenamine, 9-fluorenol, 2,7-dibromofluorene, 9-aminofluorene hydrochloride, 2,7-diaminofluorene, 9,9'-spirobi[9H-fluorene], 2-fluorenecarboxaldehyde, 9-fluorenylmethanol, 2-acetylfluorene, fluoranthene, anthracene, 9,10-dibutoxyanthracene, 9,10-dimethoxyanthracene, 9,10-diethoxyanthracene, 2- ethyl-9,10-dimethoxyanthracene, and 9,10-dipropoxyanthracene; pyrene; 1,2-benzanthracene; perylene; tetracene; coronene; thioxanthones such as thioxanthone, 2-methylthioxanthone, 2-ethylthioxanthone, 2-chlorothioxanthone, 2-isopropylthioxanthone, and 2,4-diethylthioxanthone; phenothiazines such as phenothiazine, N-methylphenothiazine, N-ethylphenothiazine, and N-phenylphenothiazine; xanthones; naphthalenes such as 1-naphthol, 2-naphthol, 1-methoxynaphthalene, 2-methoxynaphthalene, 1,4-dihydroxynaphthalene, and 4-methoxy-1-naphthol; ketones such as dimethoxyacetophenone, diethoxyacetophenone, 2-hydroxy-2-methyl-1-phenylpropane-1-one, 4'-isopropyl-2-hydroxy-2-methylpropiophenone, and 4-benzoyl-4'-methyldiphenyl sulfide; carbazoles such as N-phenylcarbazole, N-ethylcarbazole, poly-N-vinylcarbazole, and N-glycidylcarbazole; chrysene such as 1,4-dimethoxychrysene and 1,4-di-α-methylbenzyloxychrysene; and phenanthrenes such as 9-hydroxyphenanthrene, 9-methoxyphenanthrene, 9-hydroxy-10-methoxyphenanthrene, and 9-hydroxy-10-ethoxyphenanthrene. Note that when a triarylsulfonium salt is used as the photopolymerization initiator, it is preferable to use anthracene, perylene, or phenothiazine having high reducing properties, as the photosensitizer.

In addition, examples of the photosensitizer include an intramolecular cleavage-type photoradical polymerization initiator and a hydrogen abstraction-type photoradical polymerization initiator. The intramolecular cleavage-type photoradical polymerization initiator is a radical initiator configured to generate radicals by cleaving the compound when irradiated with active energy rays. Specific examples of the intramolecular cleavage-type photoradical polymerization initiator include benzyl ketal-based photoradical polymerization initiators, α-hydroxyacetophenone-based photoradical polymerization initiators, benzoin-based photoradical polymerization initiators, aminoacetophenone-based photoinitiators, oxime ketone-based photoradical polymerization initiators, acylphosphine oxide-based photoradical polymerization initiators, titanocene-based photoradical polymerization initiators, S-phenyl thiobenzoate polymerization initiators, and polymerized derivatives of these. Among these intramolecular cleavage-type radical initiators, benzyl ketal-based photoradical polymerization initiators, α-hydroxyacetophenone-based photoradical polymerization initiators, benzoin-based photoradical polymerization initiators, aminoacetophenone-based photoinitiators, oxime ketone-based photoradical polymerization initiators, and acylphosphine oxide-based photoradical polymerization initiators are preferred because of compatibility with the above-described photopolymerization initiators and excellent photocurability, and more preferred are α-hydroxyacetophenone-based photoradical polymerization initiators, benzoin-based photoradical polymerization initiators, aminoacetophenone-based photoinitiators, and oxime ketone-based photoradical polymerization initiators.

Examples of the hydrogen abstraction-type photoradical polymerization initiator include benzophenone-based photoradical initiators, thioxanthone-based photoradical polymerization initiators, and anthraquinone-based photoinitiators.

### 3. Assembling Method of Bearing Device

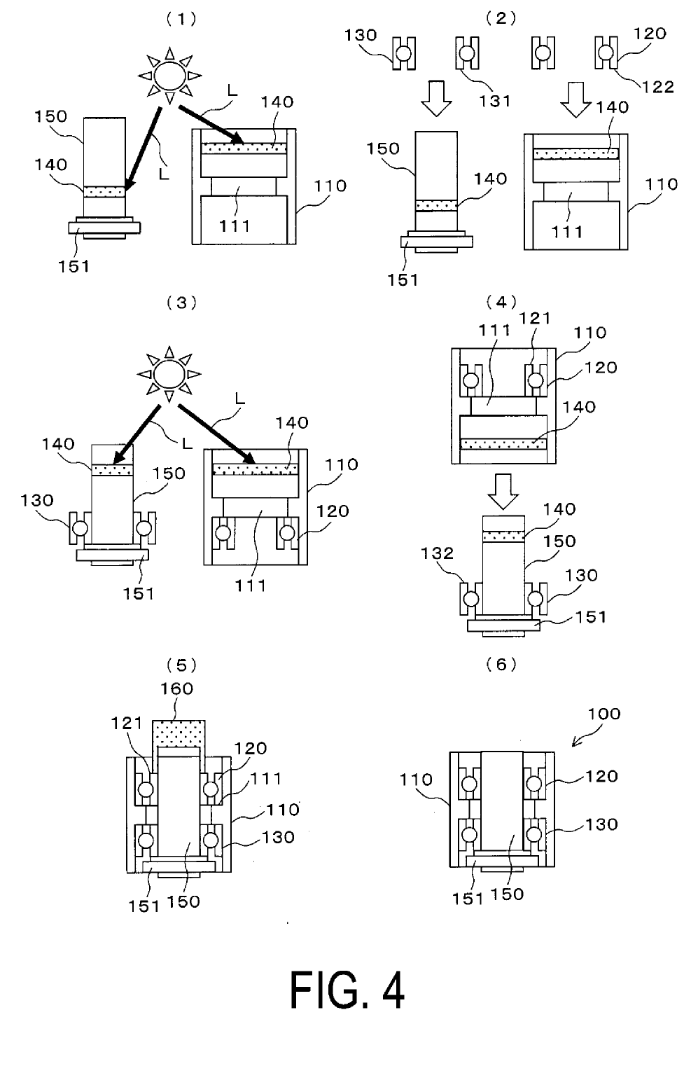

An assembling method of the bearing device 100 having the above-described configuration will be described with reference to FIG. 4. First, the sleeve 110 and the shaft 150 are obtained by an appropriate processing method. Next, the metallic nickel coatings 118 are formed at the surfaces of the sleeve 110 by electroless nickel plating, and the metallic nickel coatings 153 are formed at the surfaces of the shaft 150. The metallic nickel coatings are formed at the entire surfaces of the members (including the inner peripheral surface of the sleeve 110). Next, the bearing device 100 is assembled by performing the following steps (1) to (6).

(1) The adhesive 140 is applied to the outer periphery of an end part of the shaft 150 near the flange part 151, and the adhesive 140 is applied to the inner periphery of a part of the sleeve 110 on one end side. Next, the adhesives 140 are irradiated with ultraviolet light L.

(2) Before the adhesives 140 begin to be cured, the second ball bearing 130 is fitted onto the shaft 150 and pushed to the adhesive 140 until the end face of the inner ring 131 abuts against the flange part 151, and the first ball bearing 120 is inserted into the sleeve 110 and pushed to the adhesive 140 until the end face of the outer ring 122 abuts against the end face of the inner peripheral protruding part 111.

(3) The adhesive 140 is applied to the outer periphery of the shaft 150 on an end part side away from the flange part 151, and the adhesive 140 is applied to a part of the inner periphery of the sleeve 110 on another end side (an end side opposite to the side where the first ball bearing 120 is inserted). Next, the adhesives 140 are irradiated with the ultraviolet light L. Note that in (3), the sleeve 110 is illustrated turned upside down by 180° from the state illustrated in (2).

(4) Before the adhesives 140 begin to be cured, the shaft 150 with the second ball bearing 130 mounted is inserted into the sleeve 110 with the first ball bearing 120 mounted, and the end face of the outer ring 132 of the second ball bearing 130 is brought into contact with the end face of the inner peripheral protruding part 111. As a result, the inner peripheral surface of the inner ring 121 of the first ball bearing 120 and the outer peripheral surface of the outer ring 132 of the second ball bearing 130 come into contact with the adhesives 140.

(5) The sleeve 110 is held by a suitable jig, and the inner ring 121 of the first ball bearing 120 is pressed by a preload jig 160. In this state, the preload jig 160 is held until the adhesives are cured to a certain extent to prevent preload loss.

(6) Since the adhesives are not completely cured, the bearing device 100 is inserted into an oven and heated to complete the curing. After the curing is completed, the first hub cap 128 illustrated in FIG. 3 is fixed to the outer periphery of the shaft 150, and then the second hub cap 129 illustrated in FIG. 3 is fixed to the inner periphery of the sleeve 110.

### 4. Effects

The bearing device 100 is suitable for use in a pivot bearing device of a hard disk drive device. The hard disk drive device requires a high level of internal cleanliness. The bearing device 100 suppresses particle generation from the constituent members by forming the metallic nickel coatings at the constituent members by electroless nickel plating. Therefore, the hard disk drive device having a high level of internal cleanliness can be obtained.

However, the metallic nickel coating is incompatible with conventionally used anaerobic adhesives. Specifically, cure rate tends to be slow and strength tends to be low. In contrast, the delayed ultraviolet curing epoxy adhesives do not have these problems, even when the objects to be bonded are metallic nickel coatings. Therefore, good productivity and a strong bonding structure can be obtained.

In addition, since the adhesive 140 is an epoxy-based adhesive, it is possible to suppress outgassing. Further, since the adhesive 140 is cured by irradiation with ultraviolet light, the process from the start of assembly to the application of the preload can be performed at room temperature, and thus mass productivity is excellent. Further, since the adhesive 140 is cured with a delay after the irradiation with ultraviolet light, ease of assembly is not impaired.

In the above embodiment, the ultraviolet light L can irradiate the adhesives 140 before the members such as the first and second ball bearings 120 and 130 are brought into contact with the adhesives 140, thereby preventing the adhesives 140 from having uncured parts.

### 5. Modifications

In the first embodiment, the inner peripheral protruding part 111 is formed at the sleeve 110, but the inner peripheral protruding part 111 may be integrated with the sleeve 110 or may be a separate part. Further, instead of the inner peripheral protruding part 111, an outer peripheral protruding part may be formed at the shaft 150. In this case, the end faces of the inner rings 121 and 131 of the first and second ball bearings 120 and 130 are brought into contact with end faces of the outer peripheral protruding part, and preload is applied by pressing the outer ring 122 of the first ball bearing 120 with a preload jig 160.

### 2 Second Embodiment

The bearing device 100 is required, as an industrial product, to be low cost and to be manufactured with minimal waste of resources. One method to satisfy this requirement is to minimize use of machining and maximizing use of deformation processing when forming the constituent members. However, metal materials suitable for deformation processing have low activity and are unsuitable for bonding with anaerobic adhesives. An example solving this problem will be described below.

A basic structure of the present embodiment is the same as the basic structure of the first embodiment, except that the metallic nickel coatings 118 and 153 are not present. In this example, a sleeve 110 and a shaft 150 are made of stainless steel SUS304, and are formed into the shapes described in the first embodiment by deformation processing.

The reason why SUS304 is adopted as the material for the sleeve 110 and the shaft 150 is that SUS304 is suitable for deformation processing. By adopting deformation processing, material waste can be reduced, thereby reducing raw material costs. Further, deformation processing takes less time than machining, enabling manufacturing cost reduction. Note that some processes can be performed by machining.

When SUS304 is used as the material for the sleeve 110 and the shaft 150, deformation processing is easy, but problems arise in assembly using a conventionally used anaerobic adhesive.

This point will be described below. SUS304 does not contain Cu as an additive, so that a curing reaction is low when using an anaerobic adhesive. Therefore, a time required for curing increases, thereby reducing workability of a bonding process.

Note that SUS303Cu contains Cu as an additive for improving machinability. Therefore, the curing reaction of the anaerobic adhesive is high, resulting in good adhesion.

A delayed ultraviolet curing epoxy adhesive does not have a problem of low curing reaction of the adhesive due to a lack of metal ions contributing to the curing reaction, and a good curing reaction is obtained even when SUS304 is an object to be bonded. Alternatives to SUS304 include S10C, S20C and the like. These materials have physical properties suitable for deformation processing and are incompatible with anaerobic adhesives. The same applies to other embodiments regarding alternatives for SUS304.

A manufacturing process of the modified example will be described below. First, SUS304 is used as a material to be processed and deformation processing is used for obtaining the sleeve 110 and the shaft 150. Next, the bearing device 100 is assembled according to the procedure described in relation to FIG. 4.

In the second embodiment, the metallic nickel coatings 118 may be provided at the surfaces of the sleeve 110, and the metallic nickel coatings 153 may be further provided at the shaft 150. Alternatively, it is also possible to provide only one of the metallic nickel coatings 118 and the metallic nickel coatings 153.

### 3 Third Embodiment

### 1. Configuration of Bearing Device

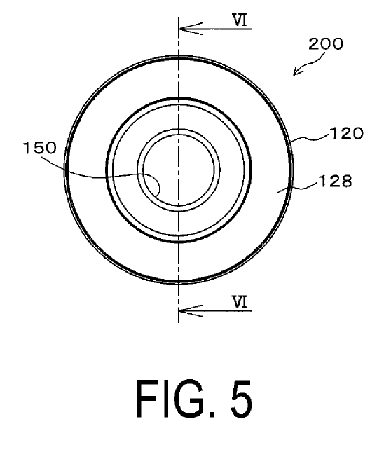

A third embodiment of the disclosure will be described with reference to FIGS. 5 to 7. A bearing device 200 according to the third embodiment differs from the first embodiment in that the sleeve 110 is not provided and a spacer 170 is provided. Therefore, similar configurations as the configurations in the first embodiment will be given the same reference signs, and descriptions of the configurations will be omitted. Note that in the present embodiment, both the case where the dust generation prevention coatings are provided (see the first embodiment) and the case where the dust generation prevention coatings are not provided (see the second embodiment) are possible.

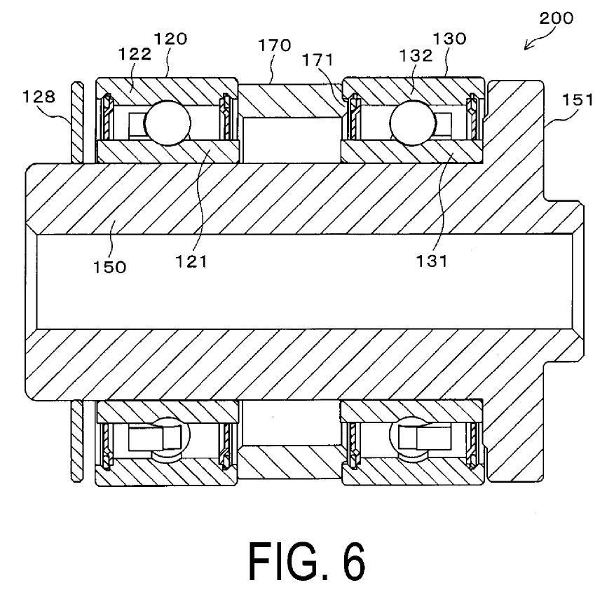

As illustrated in FIG. 6, in the bearing device 200, the spacer 170 is interposed between an outer ring 122 of a first ball bearing 120 and an outer ring 132 of a second ball bearing 130. The spacer 170 is annular, and a protruding part 171 to be fitted inside the outer ring 132 is formed at an end face of the spacer 170 on a second ball bearing 130 side. The center of the spacer 170 is aligned with the center of the outer ring 132 by the protruding part 171.

### 2. Assembling Method of Bearing Device

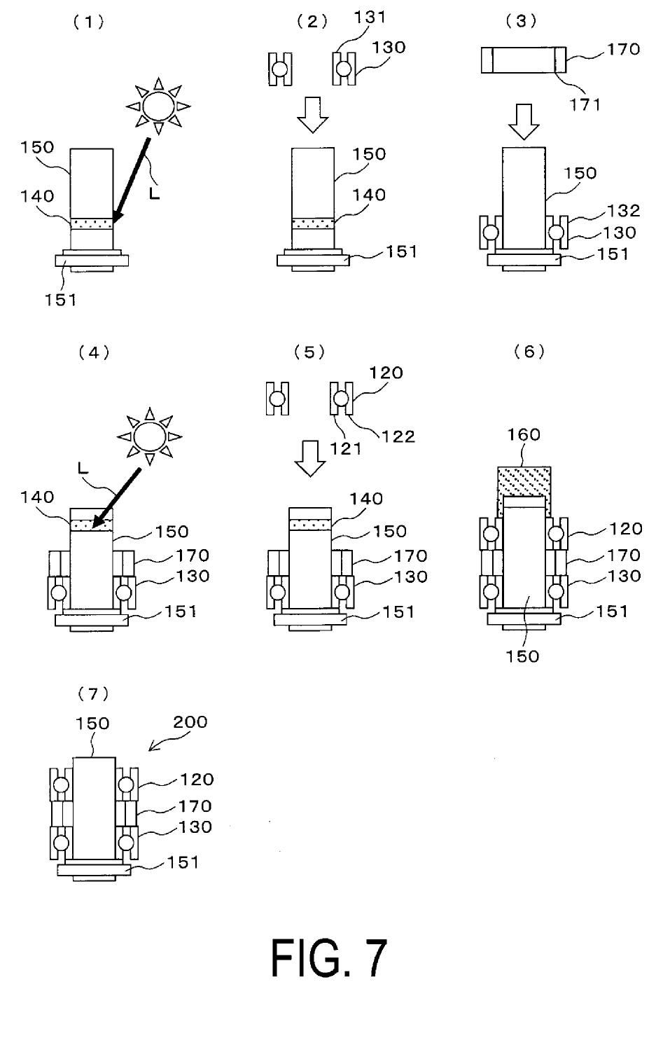

An assembling method of the bearing device 200 having the above-described configuration will be described with reference to FIG. 7.

(1) An adhesive 140 is applied to an outer periphery of a shaft 150 on an end part side near a flange part 151, and the adhesive 140 is irradiated with ultraviolet light L.

(2) Before the adhesive 140 begins to be cured, the second ball bearing 130 is fitted onto the shaft 150 and pushed to the adhesive 140 so that an end face of the inner ring 131 of the second ball bearing 130 abuts against the flange part 151.

(3) The shaft 150 is passed through the spacer 170, and the protruding part 171 of the spacer 170 is fitted to the outer ring 132 of the second ball bearing 130.

(4) The adhesive 140 is applied to the outer periphery of a part of the shaft 150 on an end part side away from the flange part 151, and the adhesive 140 is irradiated with the ultraviolet light L.

(5) Before the adhesive 140 begins to be cured, the first ball bearing 120 is fitted onto the shaft 150, and an end face of an outer ring 122 is brought into contact with an end face of the spacer 170. As a result, an inner peripheral surface of an inner ring 121 of the first ball bearing 120 comes into contact with the adhesive 140.

(6) The outer rings 122 and 132 of the first and second ball bearings 120 and 130 are held by an appropriate jig, and the inner ring 121 of the first ball bearing 120 is pressed by a preload jig 160. In this state, the preload jig 160 is held until the adhesives are cured to a certain extent to prevent preload loss.

(7) A first hub cap 128 (see FIG. 6) is fixed to the outer periphery of the shaft 150. Thereafter, since the adhesives are not completely cured, the bearing device 200 is inserted into an oven and heated to complete the curing.

In the second embodiment, the end faces of the spacer 170 are in contact with the end faces of the outer rings 122 and 132 of the first and second ball bearings 120 and 130, but may be in contact with end faces of the inner rings 121 and 131. In this case, preload is applied by pressing the outer ring 122 of the first ball bearing 120 with the preload jig 160.

### 4 Fourth Embodiment

The present embodiment is an example of a hard disk drive device using the bearing device 100 in FIG. 2A. FIG. 8 is a perspective view illustrating an overall configuration of a hard disk drive device 300 using the bearing device 100. The hard disk drive device 300 includes a base part 101 having a recessed part 117, and a spindle motor 102 and a plurality of hard disks 113 attached to the spindle motor 102 and configured to rotate are disposed in the recessed part 117. In addition, disposed in the recessed part 117 are a swing arm assembly 201 provided with swing arms 210 supporting a plurality of magnetic heads 112 each being opposed to a corresponding one of the hard disks 113, an actuator 114 configured to drive the swing arms 210, and a control unit 115 configured to control these units. Note that a cover part is attached to an upper surface of the base part 101 to hold the recessed part 117 in an airtight manner, but the cover part is omitted in FIG. 8.

The swing arm assembly 201 has a structure using the bearing device 100 to hold the swing arms 210 in a rotatable state in the hard disk drive device 300. Through holes (not illustrated) are provided in shaft parts of the swing arms 210. The bearing device 100 is fitted into the through holes. The bearing device 200 in FIG. 6 can also be used in the hard disk drive device 300.

### 5 Fifth Embodiment

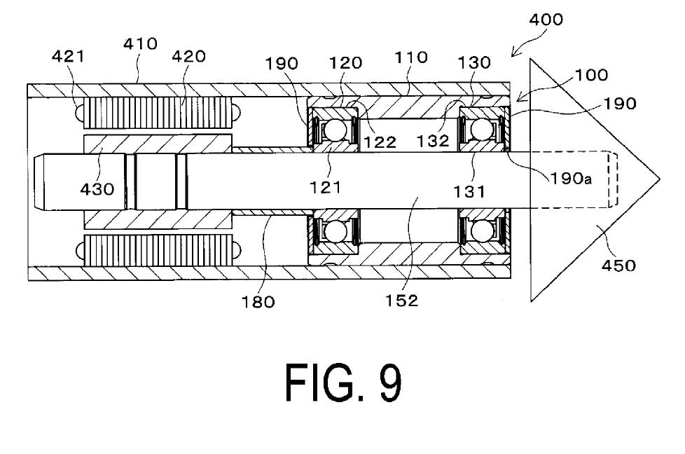

The present embodiment is an example of a motor using the bearing device 100 in FIG. 2A. FIG. 9 is a cross-sectional view illustrating a motor 400 using the bearing device 100. In this embodiment, third hub caps 190 are fixed to outer rings 122 and 132 of first and second ball bearings 120 and 130. The motor 400 uses the bearing device 100. However, in the motor 400, instead of adhesive bonding with clearances between a shaft member and inner rings in the bearing device 100, press-fitting may be used. That is, an outer peripheral surface of a shaft 152 and inner peripheral surfaces of inner rings 121 and 131 may be press-fitted, and clearances may be provided between an inner peripheral surface of a sleeve 110 and outer peripheral surfaces of the outer rings 122 and 132, and the clearances may be filled with delayed ultraviolet curing epoxy-based adhesives to adhesively bond the inner peripheral surface of the sleeve 110 and the outer peripheral surfaces of the outer rings 122 and 132.

In FIG. 9, reference sign 410 denotes a casing. The casing 410 has a cylindrical shape. An outer peripheral surface of the sleeve 110 of the bearing device 100 is fixed to an inner peripheral surface of the casing 410. A stator core 420 is fixed to the inner peripheral surface of the casing 410. The stator core 420 is formed by layering, in an axial direction, a plurality of thin sheet-like soft magnetic materials (e.g., electromagnetic steel sheets) having an annular shape, and includes a plurality of pole teeth protruding inward in a radial direction. The plurality of pole teeth are provided at equal gaps along a circumferential direction, and a coil 421 is wound around each of the pole teeth.

A spacer 180 is fixed to the shaft 152 adjacent to the inner ring 121 of the first ball bearing 120. A cylindrical rotor magnet 430 is fixed to the shaft 152 adjacent to the spacer 180. The rotor magnet 430 is magnetized so that adjacent parts along the circumferential direction have alternately opposite polarities such as S-N-S-N∙∙∙. An outer periphery of the rotor magnet 430 is opposed to inner peripheries of the pole teeth of the stator core 420 with a clearance. By supplying a drive current to the coil 421, a driving force for causing the rotor magnet 430 to rotate is generated, thereby causing the rotor magnet 430 to rotate relative to the casing 410 around the shaft 152. The shaft 152 protrudes from an opening 190a formed at the third hub cap 190, and an impeller 450 is attached to an end part of the shaft 152. In this way, the motor 400 is configured as a blower.

The bearing device 200 in FIG. 6 may also be used in the motor 400. In this case, the bearing device 200 is inserted inside the cylindrical casing 410 serving as a tubular outer member. In this structure, a clearance is provided between an outer periphery of the outer ring 122 of the first ball bearing 120 and the inner periphery of the casing 410, and the adhesive 140 is provided in the clearance (the clearance is filled with the adhesive 140), thereby fixing the outer ring 122 of the first ball bearing 120 to the inner periphery of the casing 410. In addition, a clearance is provided between an outer periphery of the outer ring 132 of the second ball bearing 130 and the inner periphery of the casing 410, and the adhesive 140 is provided in the clearance (the clearance is filled with the adhesive 140), thereby fixing the outer ring 132 of the second ball bearing 130 to the inner periphery of the casing 410.

The sleeve 110 may be fixed to the casing 410 with a delayed ultraviolet curing epoxy-based adhesive. The stator core 420 may be fixed to the casing 410 with the delayed ultraviolet curing epoxy-based adhesive. The spacer 180 may be fixed to the shaft 152 with the delayed ultraviolet curing epoxy-based adhesive. The rotor magnet 430 may be fixed to the shaft 152 with the delayed ultraviolet curing epoxy-based adhesive.

### 6 Sixth Embodiment

### 1. Configuration of Bearing Device

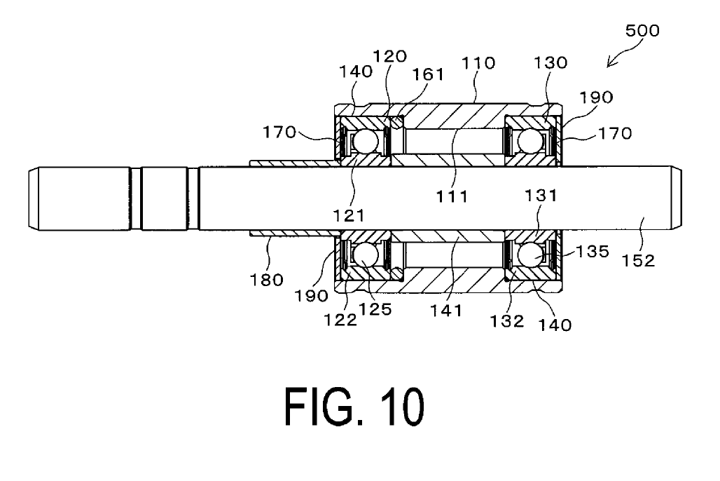

A bearing device 500 according to a sixth embodiment of the disclosure will be described with reference to FIGS. 10 to 13. In the bearing device 500, a spacer 141 is interposed between an inner ring 121 of a first ball bearing 120 and an inner ring 131 of a second ball bearing 130. The spacer 141 is press-fitted onto a shaft 152. In the present embodiment, the inner rings 121 and 131 are press-fitted onto the shaft 152 on both sides of the spacer 141. On the other hand, outer peripheral surfaces of outer rings 122 and 132 are bonded to an inner peripheral surface of a sleeve 110 on both sides of an inner peripheral protruding part 111 with adhesives 140.

An O-ring (elastic member) 161 is interposed between the outer ring 122 of the first ball bearing 120 and an end face of the inner peripheral protruding part 111. In a state illustrated in FIG. 10, the O-ring 161 is compressed, and the outer ring 122 is biased axially leftward (outward) by a reaction force of the O-ring. That is, the outer ring 122 is biased axially leftward (outward) relative to the inner ring 121, and the adhesive 140 is cured in the biased state, so that fixed position preload is applied to the first ball bearing 120. The outer ring 132 is also biased axially rightward (outward), and the fixed position preload is also applied to the second ball bearing 130.

The sleeve 110 is made of SUS304 and is obtained by deformation processing. By using a delayed ultraviolet curing epoxy-based adhesive as the adhesive 140, good workability and high adhesive strength can be obtained when bonding the outer rings 122 and 132 to the sleeve 110.

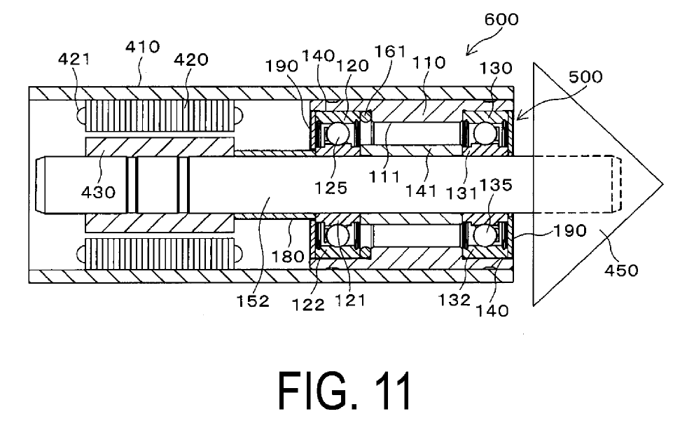

FIG. 11 illustrates a motor 600 incorporating the bearing device 500 having the above-described configuration, and the motor 600 has a similar configuration to the motor 400 illustrated in FIG. 9 as a blower, except for the bearing device 500. The bearing device 500 can be used in the structure holding the swing arms 210 in a rotatable state in a hard disk drive device 300 in FIG. 8.

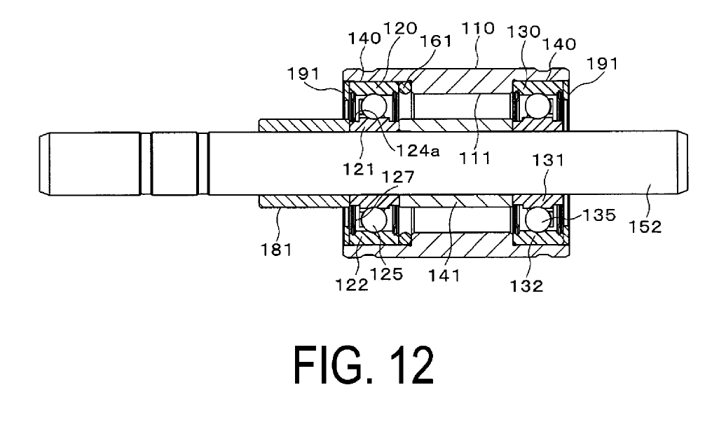

FIG. 12 illustrates a modification of the above sixth embodiment. In this modification, a thickness of a spacer 181 is made thicker than the spacer of the sixth embodiment, and an outer diameter of the spacer 181 is made larger than the inner diameter of a seal member 127 (see FIG. 3). Thus, a clearance between the seal member 127 and a step part 124a of the inner ring 121 and the spacer 181 overlap in an axial direction, thereby suppressing leakage of grease and intrusion of water, dust, and the like from the outside. Therefore, in the modification, an inner diameter of a fourth hub cap 191 is set larger.

### 2. Assembling Method of Bearing Device

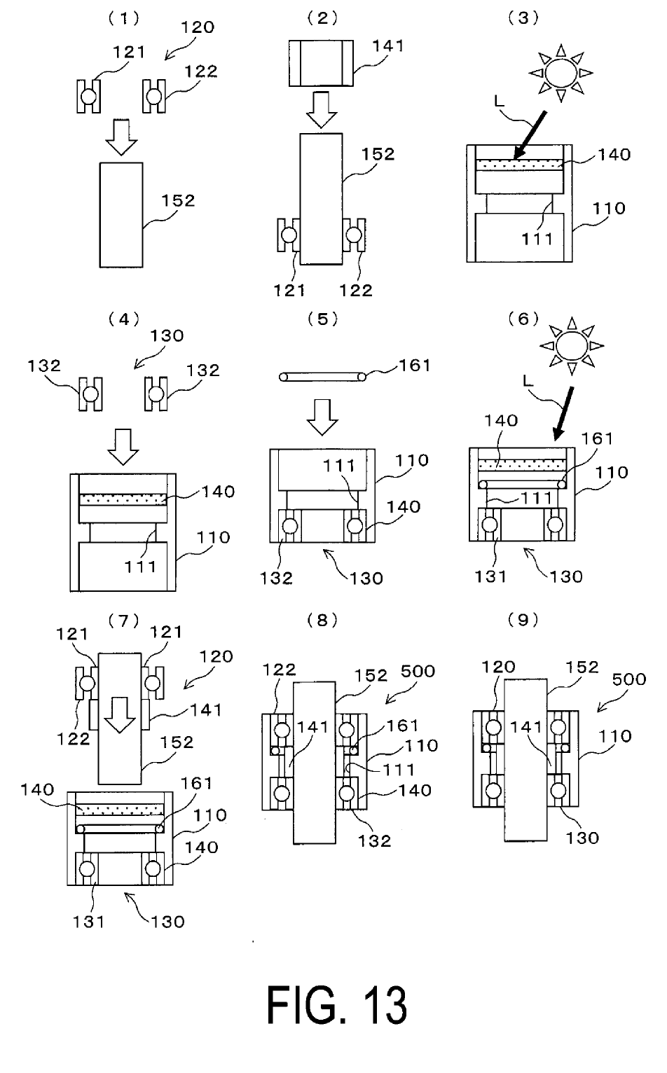

An assembling method of the bearing device 500 having the above-described configuration will be described with reference to FIG. 13.

(1) The inner ring 121 of the first ball bearing 120 is press-fitted onto the shaft 152 up to one end part of the shaft 152.

(2) The spacer 141 is press-fitted onto the shaft 152 so as to abut against an end face of the inner ring 121 of the first ball bearing 120.

(3) The adhesive 140 is applied to the inner periphery of another end part of the sleeve 110, and the adhesive 140 is irradiated with ultraviolet light L.

(4) Before the adhesive 140 begins to be cured, the second ball bearing 130 is fitted into the inner periphery of the sleeve 110, and an end face of the outer ring 132 of the second ball bearing 130 is brought into contact with an end face of the inner peripheral protruding part 111. As a result, the outer peripheral surface of the outer ring 132 comes into contact with the adhesive 140.

(5) The O-ring 161 is inserted into the inner periphery of the sleeve 110 on one end part side (on the opposite side to the second ball bearing 130 in the axial direction across the inner peripheral protruding part 111), and is brought into contact with the inner peripheral protruding part 111 of the sleeve 110.

(6) The adhesive 140 is applied to the inner periphery of the one end part of the sleeve 110, and the adhesive 140 is irradiated with the ultraviolet light L.

(7) Before the adhesive 140 begins to be cured, the shaft 152 with the spacer 141 and the inner ring 121 of the first ball bearing 120 press-fitted is inserted into the sleeve 110, and the shaft 152 is press-fitted into the inner ring 131 of the second ball bearing 130. At this time, the O-ring 161 is pressed by an end face of the outer ring 122 of the first ball bearing 120. As a result, the outer peripheral surface of the outer ring 122 of the first ball bearing 120 comes into contact with the adhesive.

(8) By leaving the bearing device 500 at room temperature in a state illustrated in FIG. 13(8), the outer ring 122 is biased to one side in the axial direction (outer side) by the reaction force of the compressed O-ring 161, and the outer ring 122 is biased to one side in the axial direction (outer side) relative to the inner ring 121, and the adhesive 140 is cured, so that fixed position preload is applied to the first ball bearing 120. Further, since the outer ring 132 of the second ball bearing 130 is also biased to another side in the axial direction (outer side), fixed position preload is also applied to the second ball bearing 130.

(9) Since the adhesives 140 are not completely cured, the bearing device 500 is inserted into an oven and heated to complete the curing. In step (4), instead of applying the adhesive 140 to the inner periphery of the sleeve 110, the adhesive 140 may be applied to the outer periphery of the outer ring 132 of the second ball bearing 130. Similarly, in step (6), instead of applying the adhesive 140 to the inner periphery of the sleeve 110, the adhesive 140 may be applied to the outer periphery of the outer ring 122 of the first ball bearing 120. Further, instead of press-fitting the shaft 152 into the inner rings 121 and 131, the shaft 152 may be fixed to the inner rings 121 and 131 with the adhesives 140.

### 7 Seventh Embodiment

### 1. Configuration of Bearing Device

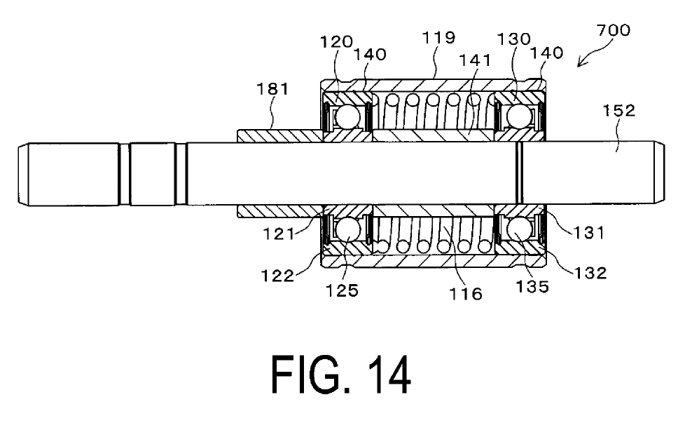

FIG. 14 illustrates a bearing device 700 according to a seventh embodiment of the disclosure. In the bearing device 700, in the modification of the sixth embodiment illustrated in FIG. 12, a sleeve 119 obtained by removing the inner peripheral protruding part 111 from the sleeve 110 is used, a coil spring (elastic member) 116 is placed at a resulting space, and the O-ring 161 and the fourth hub cap 191 are removed.

The sleeve 119 is made of SUS304 and is processed by deformation processing. The coil spring 116 is disposed between an outer ring 122 of a first ball bearing 120 and an outer ring 132 of a second ball bearing 130. The outer rings 122 and 132 are biased axially outward by a biasing force of the coil spring 116, and in this state, the outer rings 122 and 132 are fixed to an inner peripheral surface of the sleeve 119 with adhesives 140, and fixed position preload is applied to the first and second ball bearings 120 and 130. Note that the coil spring 116 may be fixed to an inner peripheral surface of the sleeve 119 with the adhesive 140 in a state after the fixed position preload is applied. In this case, it is preferable that an outer diameter of the coil spring 116 be substantially equal to an outer diameter of the outer ring 122 of the first ball bearing 120 and the outer ring 132 of the second ball bearing 130, or have a clearance fit relationship with the inner peripheral surface of the sleeve 119.

### 2. Assembling Method of Bearing Device

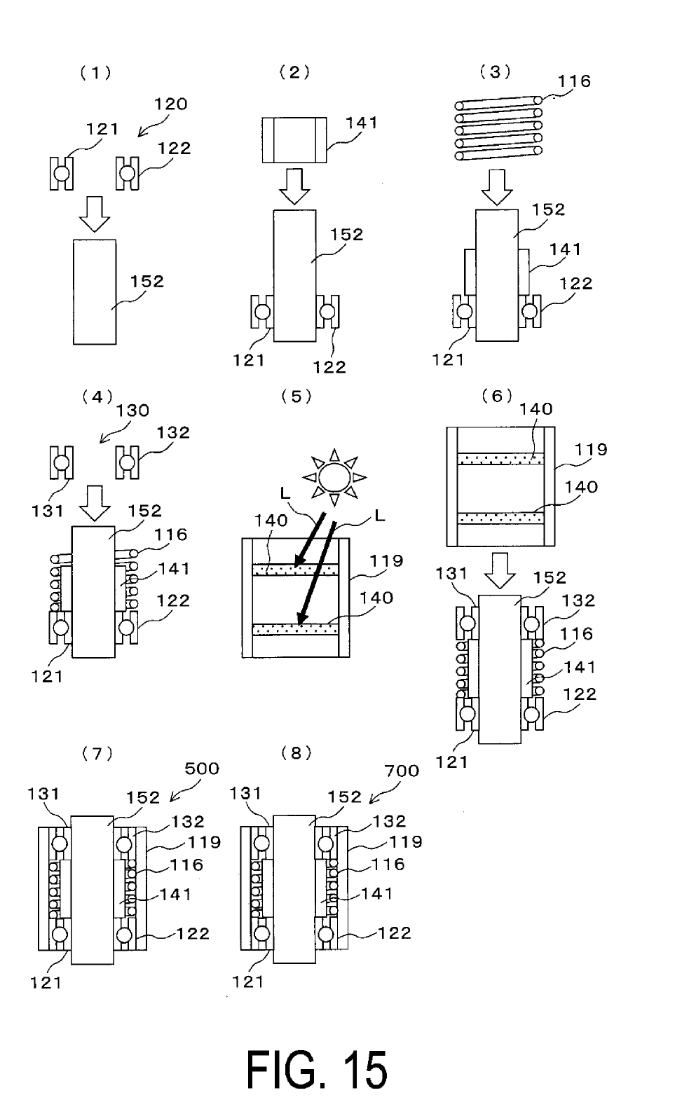

An assembling method of the bearing device 700 having the above-described configuration will be described with reference to FIG. 15.

(1) An inner ring 121 of the first ball bearing 120 is press-fitted onto a shaft 152 up to another end part of the shaft 152 (a lower end part in an axial direction in FIG. 15).

(2) A spacer 141 is press-fitted onto the shaft 152 so as to abut against an end face of the inner ring 121 of the first ball bearing 120.

(3) The shaft 152 is passed through the coil spring 116, and the coil spring 116 is brought into contact with the outer ring 122 of the first ball bearing 120.

(4) An inner ring 131 of the second ball bearing is press-fitted onto one end part of the shaft 152 (an upper end part in the axial direction in FIG. 15), and the coil spring 116 is pressed by the outer ring 132, thereby forming a bearing assembly with the first and second ball bearings 120 and 130 mounted at the shaft 152.

(5) The adhesives 140 are applied to the inner periphery of the sleeve 119 on both end sides in the axial direction, and the adhesives 140 are irradiated with ultraviolet light L.

(6) Before the adhesives 140 begin to be cured, the bearing assembly prepared in step (4) is fitted into the sleeve 119. As a result, the outer peripheral surfaces of the outer rings 122 and 132 of the first and second ball bearings 120 and 130 come into contact with the adhesives 140.

(7) By leaving the bearing device 700 at room temperature in a state illustrated in FIG. 15(7), the outer rings 122 and 132 are biased toward both sides in the axial direction (outside) by a reaction force of the compressed coil spring 116, the outer rings 122 and 132 are biased toward both sides in the axial direction (outside) relative to the inner rings 121 and 131, and the adhesives 140 are cured, so that fixed position preload is applied to the first ball bearing 120 and the second ball bearing 130.

(8) Since the adhesives 140 are not completely cured, the bearing device 700 is inserted into an oven and heated to complete the curing. Note that in step (5), instead of applying the adhesives 140 to the inner periphery of the sleeve 110, the adhesives 140 may be applied to the outer peripheries of the outer rings 122 and 132 of the first and second ball bearings 120 and 130. Further, instead of press-fitting the inner rings 121 and 131 onto the shaft 152, the inner rings 121 and 131 may be fixed to the shaft 152 with the adhesives 140.

### 3. Others

The bearing device 700 can be used in the structure holding the swing arms 210 in a rotatable state in the hard disk drive device 300 in FIG. 8. The bearing device 700 can also be used in the motor 400 in FIG. 9 and the motor 600 in FIG. 11.

The disclosure can be used in industrial fields such as a pivot assembly bearing devices for hard disk drives, bearing devices for blowers used in home appliances such as dryers and cleaners, bearing devices for motors used in automobiles, and bearing devices for machine tools.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A bearing device comprising a metal constituent member bonded using a delayed ultraviolet curing epoxy-based adhesive, wherein
the constituent member is a member including a dust generation prevention coating formed at a surface of the member or a member subjected to deformation processing.

2. The bearing device according to claim 1, wherein
the dust generation prevention coating is a metallic nickel coating formed by electroless nickel plating.

3. The bearing device according to claim 1, wherein
the member coated with the dust generation prevention coating or subjected to the deformation processing does not contain Cu as an additive.

4. The bearing device according to claim 1, wherein
the member coated with the dust generation prevention coating or subjected to the deformation processing has a Cu content of 0.05wt.% or less.

5. The bearing device according to claim 1, wherein
the member coated with the dust generation prevention coating or subjected to the deformation processing is made of a material having a lower efficiency of generation of metal ions contributing to a curing reaction of an anaerobic adhesive than SUS303Cu.

6. The bearing device according to claim 1, wherein
the member coated with the dust generation prevention coating or subjected to the deformation processing has a smaller content ratio of an element contributing to generation of metal ions contributing to a curing reaction of an anaerobic adhesive than SUS303Cu.

7. The bearing device according to claim 1, wherein
a curing initiation time of the adhesive is from 10 seconds to 30 minutes after ultraviolet irradiation.

8. The bearing device according to claim 1, wherein
the adhesive has a viscosity of 100 mPa∙s to 1000 mPa∙s at 25°C before being cured.

9. The bearing device according to claim 1 wherein
the adhesive has a glass transition temperature of 100°C or higher after being cured.

10. A method of manufacturing a bearing device comprising:
forming a dust generation prevention coating at a surface of a member formed of a metal material; and
bonding the member and another member using a delayed ultraviolet curing epoxy-based adhesive.

11. The method of manufacturing a bearing device according to claim 10, wherein
the dust generation prevention coating is a metallic nickel coating.

12. The method of manufacturing a bearing device according to claim 10, wherein
a curing initiation time of the adhesive is from 10 seconds to 30 minutes after ultraviolet irradiation.

13. The method of manufacturing a bearing device according to claim 10, wherein
the adhesive has a viscosity of 100 mPa∙s to 1000 mPa∙s at 25°C before being cured.

14. The method of manufacturing a bearing device according to claim 10 wherein
the adhesive has a glass transition temperature of 100°C or higher after being cured.

15. A method of manufacturing a bearing device comprising:
obtaining a member formed of a metal material by deformation processing; and
bonding the member and another member using a delayed ultraviolet curing epoxy-based adhesive.

16. The method of manufacturing a bearing device according to claim 15, wherein
a curing initiation time of the adhesive is from 10 seconds to 30 minutes after ultraviolet irradiation.

17. The method of manufacturing a bearing device according to claim 15, wherein
the adhesive has a viscosity of 100 mPa∙s to 1000 mPa∙s at 25°C before being cured.

18. The method of manufacturing a bearing device according to claim 15 wherein
the adhesive has a glass transition temperature of 100°C or higher after being cured.

19. A hard disk drive device comprising:
a bearing device, wherein
the bearing device includes a metal constituent member bonded using a delayed ultraviolet curing epoxy-based adhesive, and
the constituent member is a member including a dust generation prevention coating formed at a surface of the member or a member subjected to deformation processing.

20. A motor comprising:
a bearing device, wherein
the bearing device includes a metal constituent member bonded using a delayed ultraviolet curing epoxy-based adhesive, and
the constituent member is a member including a dust generation prevention coating formed at a surface of the member or a member subjected to deformation processing.
